(19) United States
(12) Patent Application Publication
(10) Pub. No.: US 2007/0130031 A1
(43) Pub. Date: Jun. 7, 2007

(54) Systems and methods for automatically reassigning an order confirmation in response to an incoming order

(76) Inventors: Andreas Esau, Oestringen (DE); Hans-Ulrich Von Helmolt, Heidelberg (DE); Thomas Mayer, Leimen (DE)

Correspondence Address: SAP / FINNEGAN, HENDERSON LLP, 901 NEW YORK AVENUE, NW, WASHINGTON, DC, 20001-4413, US

(21) Appl. No.: 11/594,888

(22) Filed: Nov. 9, 2006

(30) Foreign Application Priority Data
Nov. 10, 2005 (EP) 05077571.7

(51) Int. Cl. G06Q 10/00

(52) U.S. Cl. 705/28

(57) ABSTRACT

Systems and methods are provided for automatically reassigning an order confirmation in response to an incoming order. In one implementation, a system is provided for automatically reassigning an order confirmation in response to an incoming order. The system comprises an inbound interface for interfacing with a plurality of data storage devices, in at least one of which an incoming order is stored as data and a plurality of confirmed sales orders are stored, an execution memory operable to hold a software system, and a processor for coupling to the inbound interface and the execution memory, the processor being operable to execute the software system such that the software system operates to determine the eligibility of the incoming order to determine whether goods from at least one of the confirmed sales order may be reassigned to the incoming order and to reassign goods from the at least one of the plurality of confirmed sales order to the incoming order if the determination is positive.

### TECHNICAL FIELD

The present invention generally relates the field of data processing and to computerized systems and methods for automatically reassigning an order confirmation in response to an incoming order. More particularly, and without limitation, the invention relates to systems and methods for reassigning goods from at least one of a plurality of confirmed sales orders to the incoming order if the incoming order is eligible.

### BACKGROUND INFORMATION

Supply chain management software systems such SAP's Supply Chain Management (SAP SCM) system currently exist in the industry. Such supply chain management systems may include a plurality of applications for implementing the management of the supply chain. SAP's Advanced Planning and Optimization (SAP APO) and Extended Warehouse Management (EWM) are examples of these applications. A core interface (CIF) may connect SAP SCM with online transaction processing systems (OLTP), such as SAP Customer Relations Management (SAP CRM) and Enterprise Resource Planning (ERP). Also, the core interface may connect the OLTP to the SAP APO. In supply chain management, when a product is available to be promised to a customer, it is “available to promise” (ATP). Supply chain management systems including available to promise (ATP) functionality currently exist in the industry. Supply Chain Management applications, such as SAP APO may include ATP functionality. Such systems include software for determining whether a product is available to promise. This determination may include performing an availability check when a customer calls to place an order.

In conventional supply chain management systems, the confirmation of a sales order at the cost of another item was possible only by starting backorder processing manually or in a batch mode, or by manual interference.

During the creation or change of a sales order term, an availability check normally will be executed. If all possibilities of a global (rules based) ATP to confirm the corresponding item are exhausted and at the same time there exist document items of lower priority, it is not possible to obtain the confirmation at the cost of these items in real time. A subsequent realignment of the confirmed quantity is only possible by a mass availability check run initiated at predefined points in time or by manual reduction of the confirmation and a manual reassignment of the freed quantity to the newly added item.

It is desirable to address one or more problems such as the problems identified above, in conventional systems. In particular, it is desirable to improve the performance aspects of the availability check to ensure that available quantity can be assigned to sales orders more quickly. Thus, it is further desirable to increase the speed with which aspects of the application availability check can be carried out.

### SUMMARY

In view of the foregoing, systems and methods are disclosed herein for overcoming one or more of the above-mentioned problems. In accordance with embodiments of the invention, systems and methods may be provided for automatically reassigning an order confirmation in response to an incoming order. More specifically, embodiments of the invention include systems and methods for reassigning goods from at least one of a plurality of confirmed sales orders to the incoming order if the incoming order is eligible.

In accordance with an embodiment of the invention, a system is provided for automatically reassigning an order confirmation in response to an incoming order. The system includes an inbound interface for interfacing with a plurality of data storage devices, in at least one of which an incoming order is stored as data and a plurality of confirmed sales orders are stored, an execution memory operable to hold a software system, and a processor for coupling to the inbound interface and the execution memory, the processor being operable to execute the software system such that the software system operates to determine the eligibility of the incoming order to determine whether goods from at least one of the confirmed sales order may be reassigned to the incoming order and to reassign goods from the at least one of the plurality of confirmed sales order to the incoming order if the determination is positive. In this way, a real time reassignment of order confirmations is carried out.

According to another embodiment of the present invention, there is provided a method is provided for automatically reassigning an order confirmation in response to an incoming order. The method includes the steps of interfacing with a plurality of data storage devices, in at least one of which an incoming order is stored as data and a plurality of confirmed sales orders are stored, coupling to the inbound interface and the execution memory, executing a software system to determine the eligibility of the incoming order to determine whether goods from at least one of the confirmed sales order may be reassigned to the incoming order and to reassign goods from the at least one of the plurality of confirmed sales order to the incoming order if the determination is positive.

According to an embodiment of the present invention, a user terminal may be provided that includes means operable with systems and methods consistent with the invention such as those previously described.

Embodiments of the present invention further relate to a computer readable storage medium that stores a program which, when run on a computer, controls the computer to perform systems and methods consistent with the present invention, such as those previously described.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments and aspects of the present invention. In the drawings:

FIG. 1 is a diagram showing an example of the process steps of a reassignment of order confirmation, consistent with an embodiment of the present invention;

FIG. 2 is a diagram that shows an example of a rules evaluation and an availability check for a reassignment of an order confirmation, consistent with an embodiment of the present invention;

FIG. 3 is a flow chart showing an example of a workflow, consistent with an embodiment of the present invention;

FIG. 4 is a diagram of an exemplary backorder processing (BOP) system, consistent with an embodiment of the present invention;

FIG. 5 is a diagram that shows an example of an item update including a reassignment of an order confirmation, consistent with an embodiment of the present invention;

FIG. 6 is a screenshot showing an example of an activated ODL, consistent with an embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

As previously described, SAP CRM and ERP are both examples of an OLTP system. SAP CRM or ERP may be used for daily online transaction processing, where sales orders may be entered. SAP APO is a logistic planning system that may be a component of SAP SCM. ATP may also be a component of SAP APO. A core interface CIF may connect the OLTP to the SAP APO and may provide functions to transfer the business data between the two types of systems. The ATP component may execute an availability check when a customer enquires about placing an order. To determine whether the product is available to promise, the availability check may take into account existing stock as well as the quantities of future incoming or outgoing orders that should be delivered by the date of the order. In illustrating a possible benefit, consider the following example. If a quantity (of stock or an incoming order) is promised to a first customer, a second customer may not be able to access their reserved quantity. If there is not enough quantity to honor a complete order as requested by the second customer, the order can either be confirmed at a later date, stay unconfirmed, or may be partially confirmed. Available to promise functionality can be carried out on two levels: a global level in which complete functionality is provided or on a basic level in which real stock is assessed in determining whether a product is available to promise. If the product is available to promise, the order can be confirmed. The availability check may be checked against the forecast of stock expected to be delivered. In this way, the system may check whether the customer needs will be satisfied from planned orders. Further, in a situation where there are several orders which cannot all be confirmed, those order which cannot be confirmed may become back orders. Back orders are sales documents whose order items cannot be completely confirmed as requested due to lack of availability or material shortages. Orders, including back orders, also may be assigned a priority rating such as a high priority order and a low priority order. If a high priority order cannot be confirmed immediately, it may become a back order. Back order processing (BOP) is a technical vehicle for dealing with back orders. BOP may be a tool of the ATP component, for example in SAP APO. Using BOP, an available quantity of one or more products may be reallocated using a quantity of selected requirements. BOP may be carried out as interactive BOP or batch BOP.

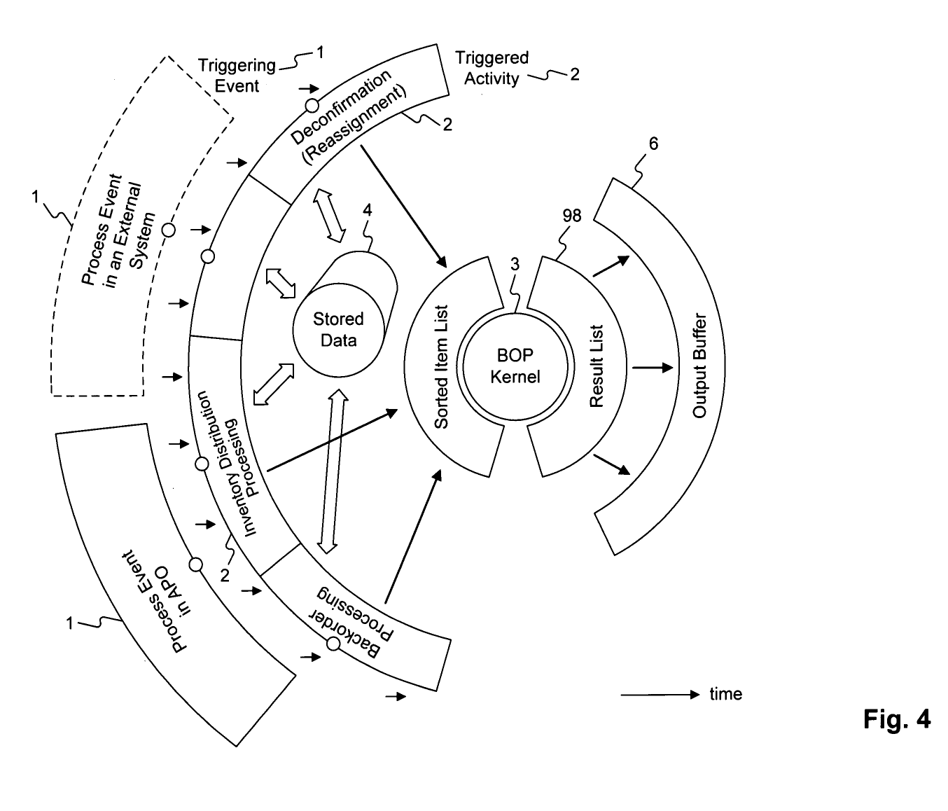

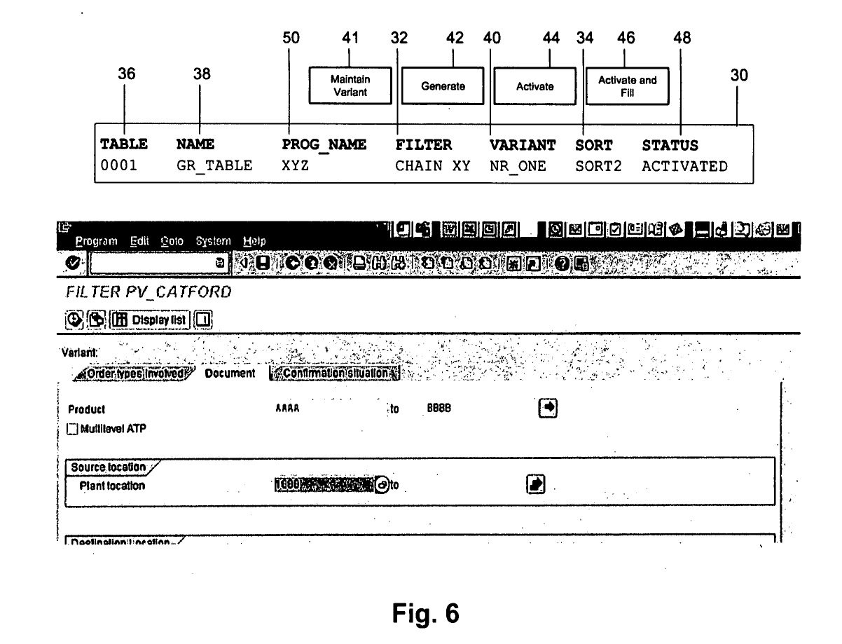

In accordance with an embodiment of the invention, the event may trigger a redistribution of the quantity, for example on cost of lower priority orders. This may be achieved using event driven quantity assignment services, wherein one or more activities, for example, backorder processing, are defined with respect to an event, as shown and described with respect to FIG. 4. Further, an order due list, described in further detail with respect to FIG. 6, may be assigned to the event. In particular, the order due lists restrict the number of order that are looked into in order to identify the affected items. Depending on the parameter values that are valid in the particular inbound interface, different ODLs can be used. The potential amount of items that are to be confirmed can be kept small by customizing the ODL. In this way, the speed of the assignment is improved. Further by customizing the ODL, for example, to identify low priority orders, their quantity can be assigned to those orders having the highest business priority. Thus, improving the efficiency of the business.

If the system is unable to confirm an order, rules based ATP (RBA) may be carried out. A rules based availability check can be used to automatically or manually optimize the decision making process between alternatives using predefined rules. A sales order item may be confirmed on the basis of RBA. After saving the sales order, its data from an OLTP system may be stored in a live cache and several database tables in SAP SCM. In general and with respect to RBA, such an item can be replaced by another item with product/location that differs from the original. This replacement can be executed by means of backorder processing (BOP). A problem in conventional supply chain management systems is that it is not possible to determine the item that can possibly receive the quantity on replacing product/location, because it is necessary to evaluate RBA anew at the moment of selection. In conventional systems a quick search of affected items is not possible. In particular, in conventional systems, once a sales order is saved, a complete rules evaluation is necessary. Thus, the quality and speed of the availability check is compromised. Consistent with an aspect of the present invention, if the system is unable to confirm an order, rules based ATP (RBA) may be carried out. The rules based availability check can be used to automatically or manually optimize the decision making process between alternatives using predefined rules. In a sales order, RBA can cause the creation of a main item with several sub-items reflecting the alternatives on product/location level. In RBA, additional criteria may be defined in order to determine the outcome if the order cannot be confirmed. For example, if a customer orders a yellow car, the rule may specify that he will be given a red car instead. Similarly, if the order cannot be confirmed from stock in a first manufacturing location, the rule may specify that the order is honored from stock in a second manufacturing location. In this way, global ATP is provided to allow, for example, a switch between locations.

According to an embodiment of the invention, the eligibility of an order item to be confirmed at the cost of other already confirmed order items may be determined. Reassignment of order confirmation is a process that may be initiated by global (rules based) ATP if all possibilities for confirmation of a higher priority item are exhausted. The process may confirm the higher priority item, and select and de-confirm lower priority items(s) according to a sort profile defined in an ODL. The sort profile may define the sequence in which the items have to be selected. The sort profile may specify the characteristics, their sequence (or weighting), and the sort direction.

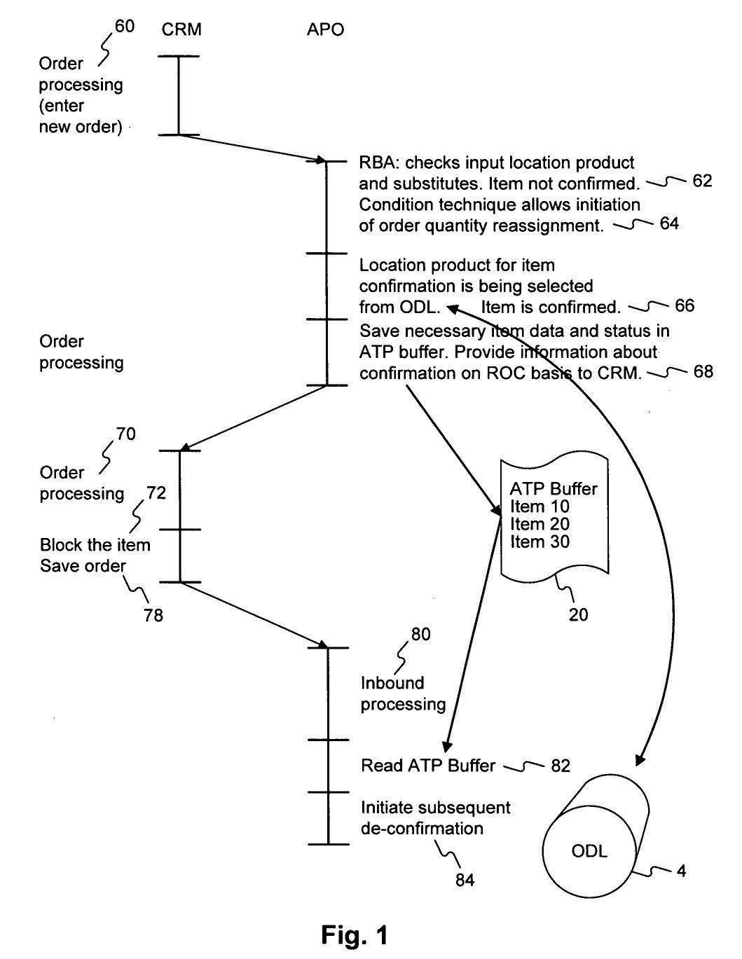

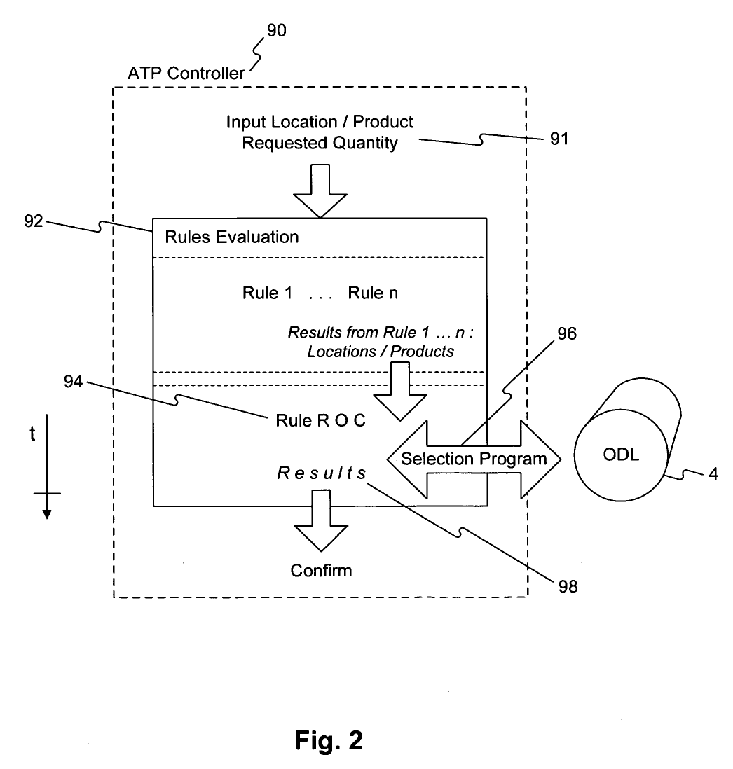

The eligibility determination may be embedded in the rules based ATP. The order may be eligible to be confirmed at the cost of others. This may occur if the rules evaluation during the ATP check leads to a rule where a special indicator, also referred to as ROC (reassignment of order confirmations), is on. In this case, the system may automatically select potential donating items corresponding to the required quantity. Potential donors may be kept in an order due list, which are described in more detail below. The confirmation of the initiating item on ROC basis may be labeled as preliminary, and this may also be communicated to the order management system. This is done to enable the OLTP system to avoid execution steps before the subsequent de-confirmation of the donating item is finished. Only then may the release of the confirmed item occur. The de-confirmation of donating items may be initiated after the order eligible to obtain confirmation on cost of other documents is saved. For this reason, in event driven global available to promise services in a supply chain management system (such as SAP SCM), a process category for reassignment of order confirmations can be defined. The activity “Sales order confirmation (ROC result)” may be assigned in the process category to the corresponding event that finally may trigger the donor de-confirmation. The de-confirmation process may be based on a mass availability check (Backorder Processing) using order due lists. The process may be embedded into a workflow model. By means of SAP business workflow, the system can react to (un-)successful process progression. The last process step is updating the order that was eligible to be confirmed at the cost of other order items. Here, the initiating order can also be de-confirmed if the de-confirmation process is unsuccessful. During the whole process, the ATP quantity may be protected by temporary quantity assignments that may be assigned to the donating respectively initiating items. In conventional systems, a redirection of the available quantity from lower priority items to higher priority items was only possible by mass availability check runs initiated at predefined points in time. This time delay leads to a business impact since confirmation of important orders is not possible at the moment of their creation. However, using reassignment of order confirmations in the supply chain management system, such as SAP SCM, in accordance with an embodiment of the invention, it is possible to trigger the quantity redirection immediately after the profiting sales order is saved. In this way, if a very important order is received for an important customer (i.e.: a high priority order), quantities from unimportant orders (i.e.: low priority orders) can be reassigned. The low priority orders may be stored in an order due list. In this way, the reassignment can be carried out online. In an embodiment of the invention, reassignment of order confirmations can be used within the framework of the ATP check, as described and shown with reference to FIGS. 1 and 2.

FIG. 1 shows an example of the process steps of a reassignment of order confirmations, according to an embodiment of the present invention. The process initiation may be embedded in the rules based ATP. If no confirmation of a higher priority item is possible, the contents of an ODL with items to be de-confirmed may be checked. Location products that were determined there may be saved in the confirmed item. Information for subsequent process steps (de-confirmation of lower priority items) may be stored in the ATP buffer 20. After the sales order is stored (step 78) in the OLTP system, the contents of the ATP buffer 20 may be analyzed in the SAP APO inbound interface (step 80). If necessary, an event may be raised and a workflow for de-confirmation of lower priority items may be started. In particular, FIG. 1 shows the interaction between SAP CRM and SAP APO according to an embodiment of the invention. In SAP CRM a new order may be entered (step 60) in order processing. For example, the new order may include a product, an amount and a date for delivery. Once entered, SAP APO may carry out an availability check, for example, an RBA (step 62). The availability check may include checking input location products and substitutes. As shown in the embodiment, the item may not confirmed. ATP rules may allow initiation of order quantity reassignment (ROC) (step 64). The location product for item confirmation may be selected from ODL, which may be stored in a database 4. The item may be confirmed (step 66). Subsequently, the necessary item data may be saved in the ATP buffer 20, and information about the confirmation on ROC basis may be provided to SAP CRM (step 68). The order processing continues (step 70). For example, the item may be blocked for further execution steps (step 72) and the order may be saved in SAP CRM (step 78). In the SAP APO inbound processing (step 80), the contents of the ATP buffer 20 may be analyzed in the inbound interface for sales orders (step 82). Further, as mentioned above, the subsequent de-confirmation may be initiated (step 84). The principle of a higher priority item may be reflected in an enhancement of rules, where a rule for ROC may be implemented. Eligibility to initiate ROC can be checked by means of one or more condition techniques within the RBA. The initiation of ROC may be dependent on different parameters, e.g. customer/order, which value(s) may allow or may not allow ROC. One or more condition techniques may used for this purpose.

FIG. 2 shows an exemplary rules evaluation and an availability check for a reassignment of an order confirmation, according to an embodiment of the present invention. The “reassignment of order confirmations” indicator may be included in the rules in RBA. Table 1 shows the rules applying to two sales orders for phones from a customer.

TABLE 1

| Product | Customer | Rule to be applied |
|---|---|---|
| phone | Customer LP | Rule 10 |
| phone | Customer HP | Rule 20 |

For the low priority customer's (Customer LP) sales order relating to a phone, Rule 10 may be applied during the availability check. Rule 10, for example, is a particular rule applied to this type of customer and may include rules such as if phone is not available from location A, source phone from location B, etc. For the high priority customer's (Customer HP) sales order relating to a phone, Rule 20 may be applied during the availability check. Rule 20 may be similar to Rule 10. However, additionally it's “reassignment of order confirmations” indicator may set, for example. This way, if the order cannot be confirmed using the other rules, the order may be confirmed at the cost of other already confirmed orders, for example, from low priority customers, such as Customer LP.

In FIG. 2, an ATP controller 90 may carry out a rules evaluation (step 92) on receipt of an input location product, with a requested quantity and requested delivery date (step 91) in the SAP APO. The rules evaluation functionality may be enhanced for rules with type “Reassignment of order confirmations” 94. In contrast to conventional RBA, a selection of valid location products may be performed based on. ODL entries stored in a database 4. If a separate ODL for order confirmations (lower priority items) is activated, a selection program 96 may executed. The selection program 96 may be executed in the following way: all in-house location products, e.g. location type=plant, that were determined by previous rules up to the current rule evaluation are taken as input for the selection from the ODL. This way the eligibility of sourcing rules is guaranteed because such restrictions (like exclusions etc.) may be considered automatically. The sequence of location products may stay the same after the selection from the ODL since prioritization of the ODL sort profile may be valid within one location product. Further, the item level of an item structure (e.g.: one to many) may be considered. The quantity that has to be confirmed and the requested delivery date may also drive the selection. Selection considers temporary quantity assignments, which may be created by reallocation processes running in parallel. Selection code may be generated by an ODL builder at the time of the ODL generation. The result 98 of the selection may be a list of location products that were selected from the ODL according to the sort profile. The table may include the following data: location selected from the ODL, product selected from ODL, confirmation time stamp to be appended into result structure, confirmed quantity to be appended into result structure, identifier of the item (GUID) to be de-confirmed.

There are situations that may be differentiated after the selection result analysis. One situation is where the selected confirmation amount matches the required quantity fully with one or more location products. A Result table exported to the controller 90 may contain this confirmation data. Another situation is where the selected confirmation amount may be lower than the required quantity. In this case, possibly existing subsequent rule(s) of the rule strategy or rule strategy sequence may be evaluated, which is a standard system behavior.

Based on the result table 98 returned from the rules evaluation 92, the availability check controller 90 may create a new requirement group and if the result table contains confirmation data, confirm the item according to the given results without performing basic method checks. The following cases may be considered: if no results are returned, the controller 90 finishes the RBA. If results with confirmation data exist, the new items will be confirmed completely. Sub-items can be created for location products that differ to the input. If results exist that do not contain confirmation data, an ATP check for the new items may be performed according to their check instruction. Furthermore, the ATP controller 90 may create temporary quantity assignments for the confirmed item and for items to be de-confirmed.

Data necessary for the de-confirmation of lower priority items may be saved as a table in the ATP buffer 20 until the high priority order item is saved in SAP APO. A table record corresponding to an item that has to be do-confirmed may contain the following data: item identifier (GUID), usage parameter, e.g. reassignment. If the ATP buffer 20 contains item data that may exist from the previous ATP check, it may be replaced with the most recent set.

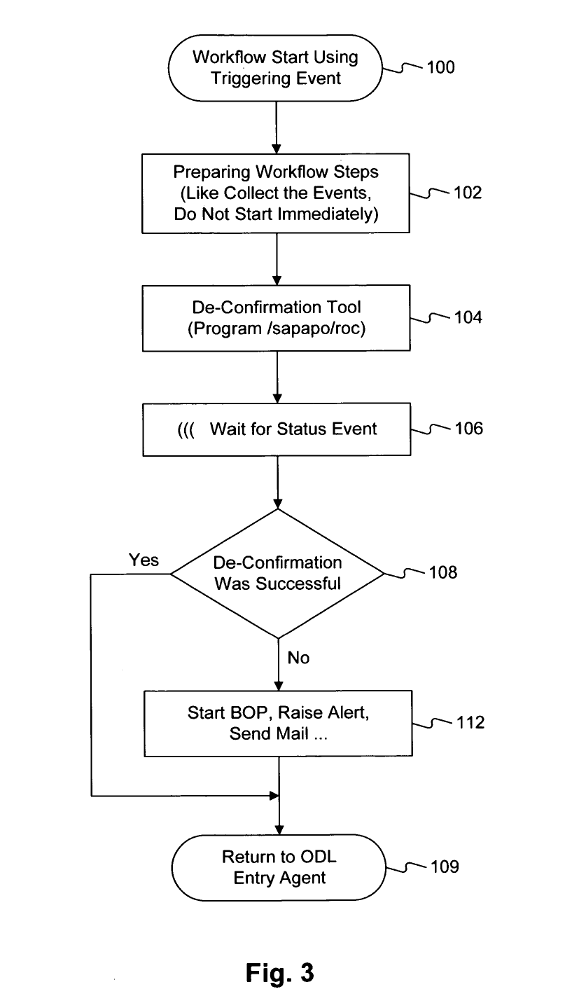

FIG. 3 shows an example of de-confirmation workflow model, according to an embodiment of the present invention. The de-confirmation process may be implemented in a workflow. The event reassignment of order confirmations may be defined as a triggering event in the workflow. Alternatively, it may be created as a separate workflow. The workflow may start using the triggering event (step 100). A preparation step may be executed, for example, by waiting until the saved high priority order data is stored in SAP APO (step 102). Then a de-confirmation BOP may import the item list from the inbound interface via temporary data storage (ATP buffer) and may update the OLTP system (step 104). The status of the executed de-confirmation BOP may be waited for (step 106). The status event may inform the workflow about (un-) successful item updates (step 108). No further steps are executed if de-confirmation was successful (step 109). If the de-confirmation was not successful, subsequent steps can be initiated (step 112). This can be for example raising an alert.

As mentioned above, the de-confirmation run within the reassignment of order confirmations may be executed by means of backorder processing. Such an embodiment is shown in FIG. 4 wherein backorder processing (BOP), including an embodiment of the invention, is shown. FIG. 4 shows an example of a flexible assignment of pre-defined events and triggering modules to start workflows that are related to back order processing (BOP). De-confirmation (reassignment) is a tool that may use ODLs as one or more inputs for the reassignment of orders after being triggered by event ROC. De-confirmation within ROC may use a processor, in particular, BOP kernel 3 and its output mechanism. Once the high priority order is saved, ROC de-confirmation may be triggered, as the triggered activity 2. ROC 2 reads the ATP buffer stored in database 4. The ATP buffer may contain a list of items to be de-confirmed, which were selected during the ATP check before saving the high priority order. Subsequently, BOP may be carried out by the BOP kernel 3. In this way, those items having the most business importance may be confirmed at the cost of lower priority confirmed orders. Order due lists are described in further detail with reference to the example of FIG. 6. The result list 98 of the BOP may be provided to an output buffer 6, which may for example, be the SAP APO storage system. The result list in the output buffer is subsequently sent to OLTP system.

In the case where the invention can be applied in back order processing, a processor 3, such as a back order kernel 3, may carry out the de-confirmation. This can include an availability check.

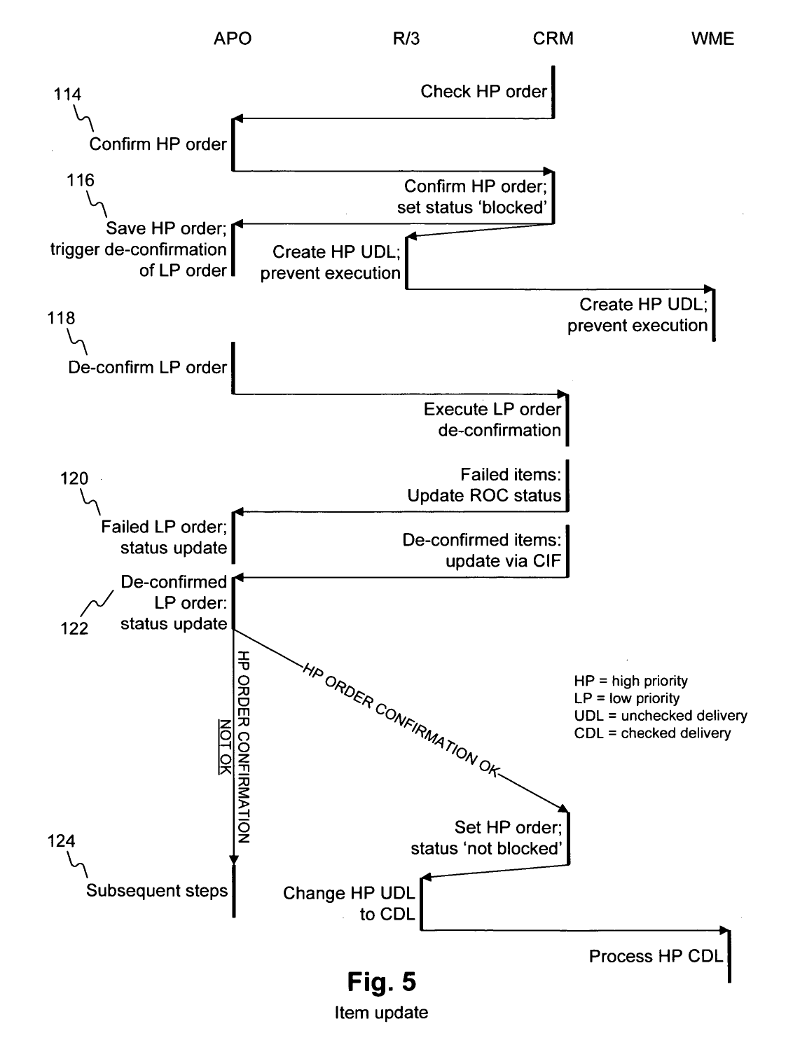

FIG. 5 shows an exemplary item update including a reassignment of an order confirmation, according to an embodiment of the present invention. In particular, FIG. 5 shows the process steps in SAP APO in correlation with process steps in order/delivery/warehouse management systems, ERP, SAP CRM, EWM, respectively. The confirmation of a higher priority order in SAP APO may involve the order management system SAP CRM. In particular, it may be expected that the order management system makes subsequent execution steps (creation of checked delivery) in ERP impossible, if the high priority item was confirmed by ROC and the de-confirmation of low priority order items is not yet processed. The high priority order may be saved (step 116). The update of high priority sales order items may obey the SAP APO inbound processes for sales orders currently being used. As described, the subsequent de-confirmation of lower priority items may be initiated (step 118). Subsequently, if at least 1 item fails, the status of the failed low priority items may be updated (step 120). Further, the status of de-confirmed lower priority items may be updated (step 122). Update of successfully proceeded sales order items obeys that currently being used in BOP update process. The de-confirmed item may then be re-processed in the order management system automatically including the processing rules of the order management. The following subsequent steps (step 124) may be implemented in SAP APO in a workflow if the de-confirmation of low priority items was not successful: for example, subsequent selection of low priority items and de-confirmation may be repeated. In this case, based on the transaction identifier of the ROC process (the identifier will stay the same), and the list of failed or successfully processed items, only low priority items selected anew may be taken into account during de-confirmation. Further, an alert may be raised.

The order management system may be updated: the high priority order is released so that subsequent execution steps, for example, conversion of unchecked delivery in checked delivery, are possible.

Order due lists are herein described in further detail with reference to the example of FIG. 6. As described, reassignment of order confirmation (ROC) may take place if a very important order for a very important customer is created or changed and no quantity is available. In such a situation, quantities can be “stolen” from unimportant orders even if they are confirmed. For example, for orders that may be defined as a low priority order, their quantities may be reassigned to high priority orders. ROC is generally not carried out in a batch process. It may be done independently of back order processing. It may be carried out on line.

ROC may use order due lists (ODL), which are described in more detail hereinafter. Order due lists may use a filter to select orders. The ODL filtering may be used if the order is saved. At the time that the order item is saved, all filters of order due lists may be scanned. If an ODL is activated, it is being filled by the system via inbound interface with corresponding OLTP documents.

The ODL may be an additional data base element that may have a restricted number of fields. It may perform the function of an index. It may be assigned to a process, for example, EDQA and may perform a pre-selection. The function performed may be that of a sorter. The ODL pre-selection can be edited manually. The pre-selection may be at least one of edited, deleted or overruled. The ODLs can be used as a reference for searching items under consideration of its priority. The order types of the handled items, the criteria to filter, and to sort them can be freely configured. Filter and sorter may be defined independent from the ODL. Selection can be aborted after the number of necessary items is reached. The selection from the ODL may obey the corresponding sort profile.

The ODL may have a type that may define the nature of items that can be contained in the ODL. The filter assigned to the ODL may comprise a filter type and a filter variant. The filter type may define the criteria and the variant may contain the values of the criteria to select the items. Per filter type several variants can be defined. The sorter assigned to the ODL may contain the criteria to sort the items. Database objects as well as source code may be generated out of the settings of an ODL. An ODL may comprise a database table with a specific database index and specific source code for table access. The generated database table may depend on the criteria that is used to calculate the item priority (sorter). The generated source code for selection from the ODL can be used, for example, by any SAP SCM application.

ODLs can be used during reassignment of quantity confirmations (ROC) as a reference to items that can lose their confirmations and during backorder processing as a work list. Using ODLs, a list of items fulfilling the criteria of the filter may be selected. The ODL may provide an index in the database table, so that all data in the table can be accessed. For example, a sales order that may be stored in LiveCache or 10 database tables where there are around 500 to 800 fields. When the ODL may be linked to the databases, the order ID may be used as a key. Accessing the database using a key is fast. The index may be used to pre-select very quickly. The index may be defined by customizing based on the sorter definition. In this way, the system finds all items associated with the order for BOP.

Order due lists may be defined, generated and activated using an ODL builder and ODL agent respectively. Generation of corresponding database tables for storage in ODL 106 may be performed by the ODL builder and based on customizable filter and sort parameters. The ODL builder may also generate selection source code, which may be used during the EDQA and filter source code that may be used for filling the index tables. The function of the ODL builder may be to build a type of cross reference for items in accordance with a chain identifier to allow a fast access to the appropriate sales orders. Once the ODL is generated, the generated tables may be filled by an ODL agent, for example, in SAP APO. The data 120, for example, “Location product A with confirmed quantity equal zero”, to be filled in the generated tables may be prepared by the rules based ATP check 16 caused by order processing in the OLTP system, for example, a SAP CRM Order Management system. The data to be filled in the tables may be buffered in an ATP buffer prior to being filled in the tables in a ODL 106 by the ODL agent. The ATP rules evaluation may store the corresponding chain ABC 102 in a temporary data buffer, ATP buffer. The data may be stored in the ATP buffer until the document is saved. The ODL is a data base object that may comprise one or more tables. The tables may be generated by the ODL building according to sort profiles to allow fast data selection. The ODL builder may build the database tables of ODL in the SAP APO. The table structure may depend on the sort profile which is used during the selection of the orders. The sort profile may define the sequence in which the items are to be processed. The sort profile may specify the characteristics, their sequence (or weighting) and the sort direction.

FIG. 6 shows an example of an activated ODL, according to an embodiment of the invention. The ODL definition 30 may include a predefined filter type 32 and filter variant 40, for example, a filter type: CHAIN XY with filter variant: NR_ONE. This forms a filter where the evaluation of the chain is enabled. Replacements of the chains containing the specified products may enhance the selection range of the product. The ODL definition 30 may also include a sort profile 34, for example, a sort profile: SORT 2. The filter type 32 and the sort profile 34 may be customizable. The ODL 30 may have an identifier 36 and a name 38. A filter variant 40 with filter conditions for a filter type can be created and used. As mentioned above, the filter may select items corresponding to the particular filter to the particular data base. For example, the filter type may define—parameter—customer type. The filter variant may define parameter value—customer type—very important or medium. The variant can be maintained by clicking on the ‘maintain variant’ icon 41. The predefined sort profile 34 may be chosen. In the example shown, the sort profile 34 is SORT2. Once the ODL is defined, the corresponding table can be generated by clicking on generate icon 42. A generated table can be activated by clicking on the activate icon 44. It can be activated and filled by data stored in a database by clicking on the icon activate and fill 46. In the example shown it is seen that the ODL definition 30 includes a status 48 which shows that the ODL is “activated”.

The ODL builder database may comprise the following object groups: structure for definition of fields valid for all filter types and sort profiles, database tables for filter definition and generation of corresponding program code statements, database tables for sort profile definition and generation of corresponding program code statements, and database tables for assigning of filter/sort to ODL tables and generation/activation of the tables.

The ODL definition may further include a filter variant definition according to an embodiment of the invention. Having chosen a filter type 32, a filter variant 40 that is valid for the filter type can be chosen. The variant may be predefined, i.e. already created and maintained. Further, the filter variant can be maintained. It is also possible to create a filter variant. The filter variant may include the filter conditions according to the filter type parameters. The filter variant 40 and the filter type 32 may build together the actual filter 32, 40. Further, a sort profile 34 can be chosen from one of the predetermined, maintained sort profiles. Within the maintenance view screen it may also possible to change ODL descriptions, delete ODLs, generate ODLs, drop and refresh code, activate ODLs 44, activate and fill tables 46, and deactivate ODLs. As mentioned, the filter type definition and the sort profile definition can be customized. Based on the sort profile 34, a database table with appropriate database index may be generated by clicking on the generate icon 42. Based on the chosen filter 32 and program code template, a program name 50 (e.g.: XYZ) and program code for filling the table by the ODL agent 14 may be generated. Based on the chosen sort profile 34 and program code template, a program name 50 and program code for selection from the table by EDQA may be generated. Once generated, the status 48 of the ODL may become GENERATED 52. It is noted that the ODL table, although generated, does not contain any entries at this point. Activation of a table by clicking on the activate icon 44 may immediately enable filling it by necessary and eligible index date. The function activate and fill 46 can be used for filling the table with index data of possibly already existing backorder items, which are eligible for the table. The table (filter/sort) can be valid for greater than or equal to 1 trigger events 1. Reassigning a filter/sort makes ODL organization necessary. For example, if it is decided to use a different filter but the existing data does not meet the conditions of reorganizing. Below the ODL definition a screen shot shows an example of a filter variant. The filter parameters ‘product’ and ‘source location’ may be chosen and can be maintained.

It is to be noted that the above-mentioned embodiments illustrate rather than limit the invention, and that those skilled in the art will be able to design alternatives without departing from the scope of the appended claims. For example, the computational aspects described here can be implemented in digital electronic circuitry, or in computer hardware, firmware, software, or in combinations of them. Where appropriate, aspects of these systems and techniques can be implemented in a computer program product tangibly embodied in a machine-readable storage device for execution by a programmable processor, and method steps can be performed by a programmable processor executing a program of instructions to perform functions by operating on input data and generating output. The mere fact that certain measures are recited in mutually different claims does not indicate that a combination of these measures cannot be used to advantage.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for automatically reassigning an order confirmation in response to an incoming order, the system comprising:
an inbound interface for interfacing with a plurality of data storage devices, in at least one of which an incoming order is stored as data and a plurality of confirmed sales orders are stored;
an execution memory operable to hold a software system; and
a processor for coupling to the inbound interface and the execution memory, the processor being operable to execute the software system such that the software system operates to determine the eligibility of the incoming order to determine whether goods from at least one of the confirmed sales order may be reassigned to the incoming order and to reassign goods from the at least one of the plurality of confirmed sales order to the incoming order if the determination is positive.

2. The system of claim 1, wherein the software system operates to determine if a determination with respect to the eligibility is embedded in a rules based available to promise determination.

3. The system of claim 2, wherein the rules based available to promise determination includes a rule defining which orders may be confirmed by reassigning goods from one or more of a plurality of confirmed sales orders.

4. The system of claim 1, wherein the software system operates to determine from which of the plurality of confirmed orders an incoming order may be confirmed using one or more order due lists.

5. The system of claim 4, wherein the one or more order due lists include a list of those of the plurality of confirmed sales orders which may be reassigned to the incoming order.

6. The system of claim 5, wherein the one or more order due lists are stored in a database and are accessible by the processor.

7. The system of claim 1, wherein the software system operates to de-confirm at least one of the plurality of confirmed sales orders if an incoming sales order is identified as being eligible for a reassignment of goods from a confirmed order.

8. The system of claim 1, wherein the software system operates to reassign the goods in real time.

9. A method of automatically reassigning an order confirmation in response to a subsequent incoming order, the method comprising:
interfacing with a plurality of data storage devices in at least one of which an incoming order is stored as data and a plurality of confirmed sales orders are stored;
coupling to the inbound interface and the execution memory; and
executing a software system to determine the eligibility of the incoming order to determine whether goods from at least one of the confirmed sales order may be reassigned to the incoming order and to reassign goods from the at least one of the plurality of confirmed sales order to the incoming order if the determination is positive.

10. The method of claim 9, wherein the executing step further comprises determining if a determination with respect to the eligibility is embedded in a rules based available to promise determination.

11. The method of claim 10, wherein the rules based available to promise determination includes a rule defining which orders may be confirmed by reassigning goods from one or more of a plurality of confirmed sales orders.

12. The method of claim 9, wherein the executing step further comprises determining from which of the plurality of confirmed orders an incoming order may be confirmed using one or more order due lists.

13. The method of claim 12, wherein the one or more order due lists include a list of those of the plurality of confirmed sales orders which may be reassigned to the incoming order.

14. The method of claim 13, wherein the one or more order due lists are stored in a database and are accessible by the processor.

15. The method of claim 9, wherein the executing step further comprises operating to de-confirm at least one of the plurality of confirmed sales orders if an incoming sales order is identified as being eligible for a reassignment of goods from a confirmed order.

16. The method of claim 9, wherein the executing step further comprises operating to reassign the goods in real time.

17. The method of claim 9, further comprising employing a user terminal

18. A computer readable storage medium storing a program which when run on a computer controls the computer to perform a method of automatically reassigning an order confirmation in response to a subsequent incoming order, the method comprising:
interfacing with a plurality of data storage devices, in at least one of which an incoming order is stored as data and a plurality of confirmed sales orders are stored;
coupling to the inbound interface and the execution memory; and
executing a software system to determine the eligibility of the incoming order to determine whether goods from at least one of the confirmed sales order may be reassigned to the incoming order and to reassign goods from the at least one of the plurality of confirmed sales order to the incoming order if the determination is positive.

19. The computer readable storage medium of claim 18, wherein the executing step further comprises determining if a determination with respect to the eligibility is embedded in a rules based available to promise determination.

20. The computer readable storage medium of claim 19, wherein the rules based available to promise determination includes a rule defining which orders may be confirmed by reassigning goods from one or more of a plurality of confirmed sales orders.

21. The computer readable storage medium of claim 18, wherein the executing step further comprises determining from which of the plurality of confirmed orders an incoming order may be confirmed using one or more order due lists.

22. The computer readable storage medium of claim 21, wherein the one or more order due lists include a list of those of the plurality of confirmed sales orders which may be reassigned to the incoming order.

23. The computer readable storage medium of claim 22, wherein the one or more order due lists are stored in a database and are accessible by the processor.

24. The computer readable storage medium of claim 18, wherein the executing step further comprises operating to de-confirm at least one of the plurality of confirmed sales orders if an incoming sales order is identified as being eligible for a reassignment of goods from a confirmed order.

25. The computer readable storage medium of claim 18, wherein the executing step further comprises operating to reassign the goods in real time.
